(19) United States
(12) Patent Application Publication
(10) Pub. No.: US 2022/0161330 A1
(43) Pub. Date: May 26, 2022

(54) DROSS REMOVAL METHODS AND DEVICES FOR MAGNETOHYDRODYNAMIC JETTING OF METALS IN 3D PRINTING APPLICATIONS

(71) Applicant: Desktop Metal, Inc., Burlington, MA (US)

(72) Inventors: Mark Gardner Gibson, Carlisle, MA (US); Julian Bell, Jamaica Plain, MA (US); Emanuel Michael Sachs, Newton, MA (US)

(73) Assignee: Desktop Metal, Inc., Burlington, MA (US)

(21) Appl. No.: 17/438,438

(22) PCT Filed: Mar. 20, 2020
(86) PCT No.: PCT/US2020/023961

§ 371 Date: Sep. 12, 2021

Related U.S. Application Data
(60) Provisional application No. 62/822,155, filed on Mar. 22, 2019.

(51) Int. Cl. B22F 12/00; B33Y 40/00; B08B 5/04; B08B 13/00

(52) U.S. Cl. CPC B22F 12/00; B08B 13/00; B08B 5/04; B33Y 40/00

(57) ABSTRACT

A dross removal system for magnetohydrodynamic additive. A vacuum source is used to create a pressure differential at a nozzle opening sufficient to collect dross from a pool of molten metal. The dross and any collected molten metal can be captured in a waste bin for later disposal. 308

### FIELD OF THE DISCLOSURE

The subject matter of the present disclosure generally relates to dross removal, and more particularly relates to removing dross from a pool of liquid metal using a dross remover.

### BACKGROUND OF THE DISCLOSURE

Controlled magnetohydrodynamic pulsing may be used to selectively jet individual drops of molten metals and additively build up three-dimensional geometries, in a process known as magnetohydrodynamic printing (here referred to as MHD printing, or MHD). In one embodiment of this process, a jetting apparatus (here referred to as the nozzle) is employed to heat solid metal feedstock above its liquidus temperature to create molten metal; contain the molten metal; keep the molten metal above its liquidus temperature; position the body of molten metal relative to a magnetic field; enable an electric current to be passed through the molten metal to create a magnetohydrodynamic pulse; and direct the flow of molten metal towards a desired target.

A side effect of the process of melting solid feedstock into liquid metal and then maintaining a volume of metal in the molten state is that dross—collected solid impurities, frequently including oxides of the molten metal in use—is formed. In the case of highly reactive metals like aluminum, metal oxide dross can form extremely rapidly on the exposed surface of the molten metal, even if the nozzle is operated in an inert environment, such as a high-purity argon environment, thanks to the presence of trace oxygen and water vapor in the environment. The process of melting solid feedstock may also produce dross, as contaminants and existing oxides/other metallic compounds on the surface of the solid feedstock slough off as the material melts. Dross frequently floats on the surface of a body of molten metal, but may also in certain circumstances be mixed into the molten metal. Depending on the temperature that the molten metal is held at, the dross may eventually reduce, or may remain stable. For instance, in the case of molten aluminum, the dross is generally stable at the liquidus temperature of the aluminum.

During MHD jetting, dross particles can be drawn into the nozzle exit by the magnetohydrodynamic pulsing. Since these particles may not melt, the dross particle may partially or completely obstruct the nozzle exit, temporarily or permanently. Depending on the mechanism of obstruction, it may be difficult to remove the dross particle from the nozzle. Consequently, it is preferable to minimize the amount of dross that can be introduced into the body of molten metal.

### SUMMARY

Disclosed is a dross removal system for use with MHD printers. A vacuum source is employed to create a pressure differential at a nozzle of a dross remover to remove dross from a pool of molten metal. In certain embodiments, a filter may be employed within a flow path inside a dross remover body. In other embodiments, a retractable pin can be used to clear an internal throat of a nozzle or to remove dross from a splat pad. In certain embodiments, the dross remover may be positioned such that the nozzle is not aligned with the vector of gravity so that dislodged dross falls into a waste bin.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a block diagram of an additive manufacturing system for magnetohydrodynamic molten metal printing.

FIGS. 2A-C are depictions of the nozzle of the system of FIG. 1.

FIGS. 3A-C depict a dross remover system.

FIGS. 4A-C depict a vacuum bag dross remover.

FIGS. 5A-B depict a nozzle entrapment dross remover with a reverse taper nozzle.

FIGS. 6A-B depict a splat pad dross remover.

FIGS. 7A-B depict a pin entrapment dross remover.

FIG. 8 depicts an alternative nozzle of the system in FIG. 1, and two possible locations where dross removal might occur.

FIG. 9 depicts a spring-powered dross remover.

### DETAILED DESCRIPTION

Disclosed herein are systems and methods for the removal of dross from pools of molten metal. First described however is an MHD printing system for use in understanding the remainder of the disclosure.

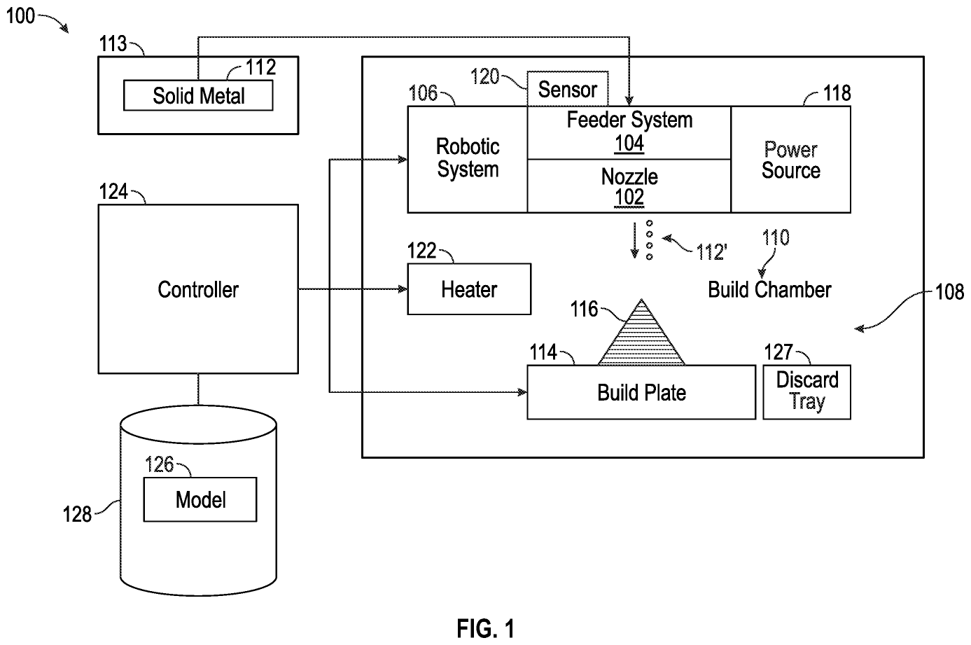

FIG. 1 is a schematic depiction of an additive manufacturing system 100 using MEM printing of liquid metal 100 in which the disclosed improvements may be employed. Additive manufacturing system 100 can include a nozzle 102, a feeder system 104, and a robotic system 106. In general, the robotic system 106 can move the nozzle 102 along a controlled pattern within a working volume 108 of a build chamber 110 as the feeder system 104 moves a solid metal 112 from a metal supply 113 and into the nozzle 102. As described in greater detail below, the solid metal 112 can be melted via heater 122 in or adjacent to the nozzle 102 to form a liquid metal 112′ and, through a combination of a magnetic field and an electric current acting on the liquid metal 112′ in the nozzle 102, MHD forces can eject the liquid metal 112′ from the nozzle 102 in a direction toward a build plate 114 disposed within the build chamber 110. Through repeated ejection of the liquid metal 112′ as the nozzle 102 moves along the controlled pattern, an object 116 (e.g., a two-dimensional object or a three-dimensional object) can be formed. The object may be formed based on a model 126 enacted through a controller 124. In certain embodiments, the object 116 can be moved under the nozzle 102 (e.g., as the nozzle 102 remains stationary). For example, in instances in which the controlled pattern is a three-dimensional pattern, the liquid metal 112′ can be ejected from the nozzle 102 in successive layers to form the object 116 through additive manufacturing. Thus, in general, the feeder system 104 can continuously, or substantially continuously, provide build material to the nozzle 102 as the nozzle 102 ejects the liquid metal 112′, which can facilitate the use of the three-dimensional printer 100 in a variety of manufacturing applications, including high volume manufacturing of metal parts. As also described in greater detail below, MHD forces can be controlled in the nozzle 102 to provide drop-on-demand delivery of the liquid metal 112′ at rates ranging from about one liquid metal drop per hour to thousands of liquid metal drops per second and, in certain instances, to deliver a substantially continuous stream of the liquid metal 112′. A sensor or sensors 120 may monitor the printing process as discussed further below.

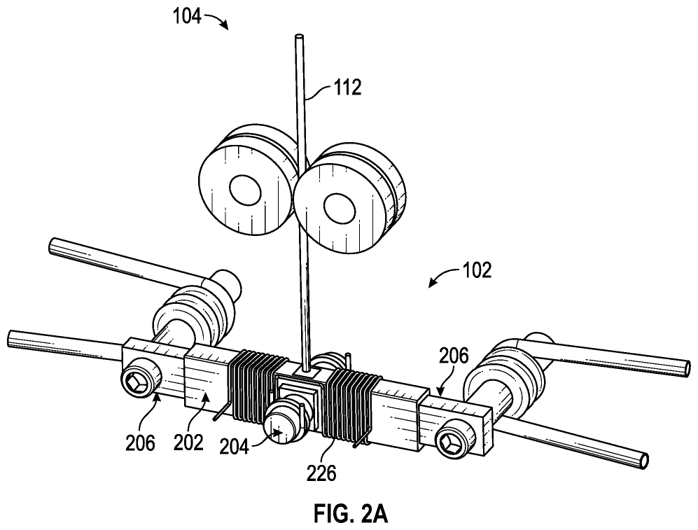

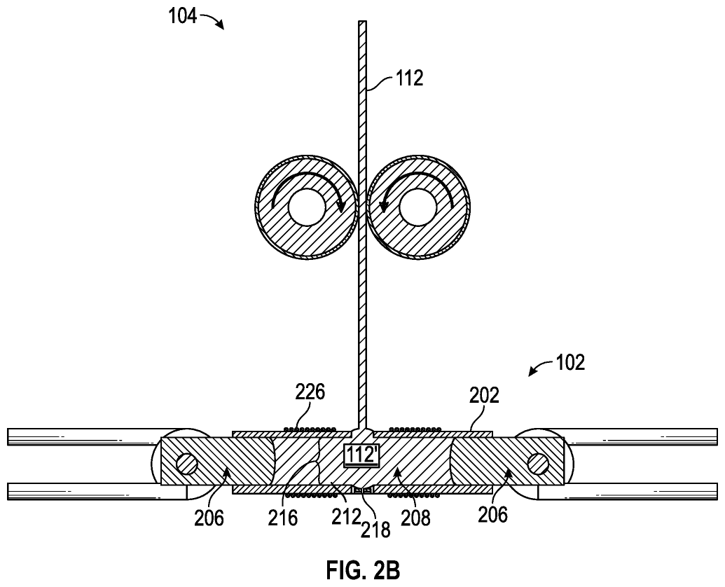

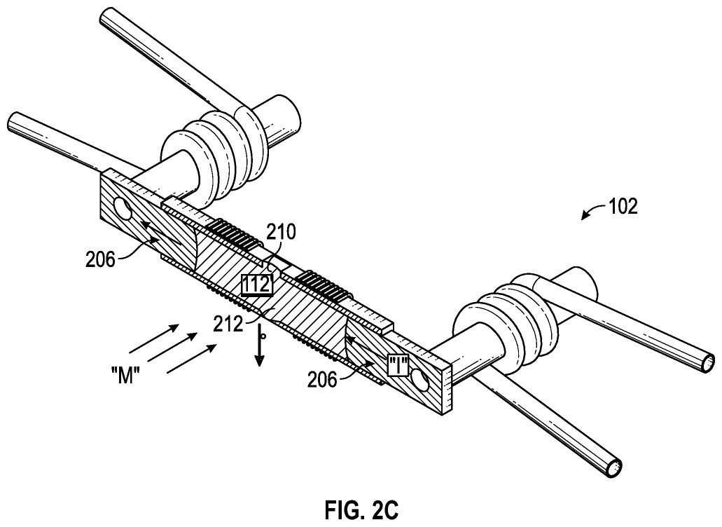

Now with reference to FIGS. 2A-D which depict the nozzle of the printer of FIG. 1. The nozzle can include a housing 202, one or more magnets 204, and electrodes 206. The housing 202 can define at least a portion of a fluid chamber 208 having an inlet region 210 and a discharge region 212. The one or more magnets 204 can be supported on the housing 202 or otherwise in a fixed position relative to the housing 202 with a magnetic field “M” generated by the one or more magnets 204 directed through the housing 202. In particular, the magnetic field can be directed through the housing 202 in a direction intersecting the liquid metal 112′ as the liquid metal 112′ moves from the inlet region 210 to the discharge region 212. Also, or instead, the electrodes 206 can be supported on the housing 202 to define at least a portion of a firing chamber 216 within the fluid chamber 208, between the inlet region 210 and the discharge region 212. In use, the feeder system 104 can engage the solid metal 112 and, additionally or alternatively, can direct the solid metal 112 into the inlet region 210 of the fluid chamber 208 as the liquid metal 112′ is ejected through the discharge orifice 218 through MHD forces generated using the one or more magnets 204 and the electrodes 206. A heater 226 may be employed to heat the housing 202 and the fluid chamber 208 to melt the solid metal 112. A discard tray 127 is located in proximity to the build plate and the nozzle may deposit droplets in it during a testing or calibration step.

In certain implementations, an electric power source 118 can be in electrical communication with the electrodes 206 and can be controlled to produce an electric current “I” flowing between the electrodes 206. In particular, the electric current “I” can intersect the magnetic field “M” in the liquid metal 112′ in the firing chamber 216. It should be understood that the result of this intersection is an MHD force (also known as a Lorentz force) on the liquid metal 112′ at the intersection of the magnetic field “M” and the electric current “I”. Because the direction of the MHD force obeys the right-hand rule, the one or more magnets 204 and the electrodes 206 can be oriented relative to one another to exert the MHD force on the liquid metal 112′ in a predictable direction, such as a direction that can move the liquid metal 112′ toward the discharge region 212. The MHD force on the liquid metal 112′ is of the type known as a body force, as it acts in a distributed manner on the liquid metal 112′ wherever both the electric current “I” is flowing and the magnetic field “M” is present. The aggregation of this body force creates a pressure which can lead to ejection of the liquid metal 112′. It should be appreciated that orienting the magnetic field “M” and the electric current substantially perpendicular to one another and substantially perpendicular to a direction of travel of the liquid metal 112′ from the inlet region 210 to the discharge region 212 can result in the most efficient use of the electric current “I” to eject the liquid metal 112′ through the use of MHD force.

In use, the electrical power source 118 can be controlled to pulse the electric current “I” flowing between the electrodes 206. The pulsation can produce a corresponding pulsation in the MHD force applied to the liquid metal 112′ in the firing chamber 216. If the pulse is of sufficient magnitude and duration, the pulsation of the MHD force on the liquid metal 112′ in the firing chamber 208 can eject a corresponding droplet from the discharge region 212.

In certain implementations, the pulsed electric current “I” can be driven in a manner to control the shape of a droplet of the liquid metal 112′ exiting the nozzle 102. In particular, because the electric current “I” interacts with the magnetic field “M” according to the right-hand rule, a change in direction (polarity) of the electric current “I” across the firing chamber 216 can change the direction of the MHD force on the liquid metal 112′ along an axis extending between the inlet region 210 and the discharge region 212. Thus, for example, by reversing the polarity of the electric current “I” relative to the polarity associated with ejection of the liquid metal 112′, the electric current “I” can exert a pullback force on the liquid metal 112′ in the fluid chamber 208.

Each pulse can be shaped with a pre-charge that applies a small, pullback force (opposite the direction of ejection of the liquid metal 112′ from the discharge region 212) before creating an ejection drive signal to propel one or more droplets of the liquid metal 112′ from the nozzle 102. In response to this pre-charge, the liquid metal 112′ can be drawn up slightly with respect to the discharge region 212. Drawing the liquid metal 112′ slightly up toward the discharge orifice in this way can provide numerous advantageous, including providing a path in which a bolus of the liquid metal 112′ can accelerate for cleaner separation from the discharge orifice as the bolus of the liquid metal is expelled from the discharge orifice, resulting in a droplet with a more well-behaved (e.g., stable) shape during travel. Similarly, the retracting motion can effectively spring load a forward surface of the liquid metal 112′ by drawing against surface tension of the liquid metal 112′ along the discharge region 212. As the liquid metal 112′ is then subjected to an MHD force to eject the liquid metal 112′, the forces of surface tension can help to accelerate the liquid metal 112′ toward ejection from the discharge region 212.

Further, or instead, each pulse can be shaped to have a small pullback force following the end of the pulse. In such instances, because the pullback force is opposite a direction of travel of the liquid metal 112′ being ejected from the discharge region 212, the small pullback force following the end of the pulse can facilitate clean separation of the liquid metal 112′ along the discharge region 212 from an exiting droplet of the liquid metal 112′. Thus, in some implementations, the drive signal produced by the electrical power source 118 can include a wavelet with a pullback signal to pre-charge the liquid metal 112′, an ejection signal to expel a droplet of the liquid metal, and a pullback signal to separate an exiting droplet of the liquid metal 112′ from the liquid metal 112′ along the discharge region 212. Additionally, or alternatively, the drive signal produced by the electrical power source 118 can include one or more dwells between portions of each pulse.

As used herein, the term “liquid metal” shall be understood to include metals and metal alloys in liquid form and, additionally or alternatively, includes any fluid containing metals and metal alloys in liquid form, unless otherwise specified or made clear by the context. Metals suitable for use with the disclosure include aluminum and aluminum alloys, copper and copper alloys, silver and silver alloys, gold and gold alloys, platinum and platinum alloys, iron and iron alloys, and nickel and nickel alloys.

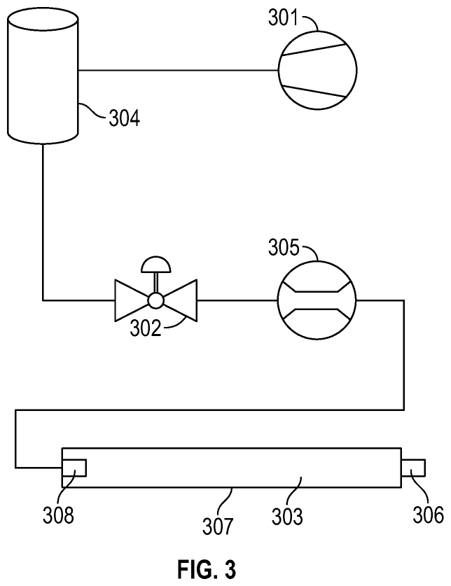

FIG. 3 presents a conceptual overview of the complete system required to operate a device for removing dross from a pool of molten metal. The system includes a vacuum source 301, preferably a vacuum pump including of the venturi or entrainment type know in the art; a valve 302, preferably a fast-acting valve, and preferably a solenoid-controlled valve; and a device that manipulates molten metal dross, referred to here as a dross remover 303. The system preferably includes a vacuum reservoir 304. The system also preferably includes a flowmeter 305 between the dross remover and the valve to detect clogs in the dross remover, failures in the valve or other conditions. The dross remover may be implemented in numerous manners, and comprises an inlet port open to ambient pressure, referred to here as the dross remover inlet 306, a body 307, and an outlet port 308. The outlet port is fluidically connected to a vacuum source with a valve 302 and flowmeter 305 optionally positioned between them.

The dross remover system operates by using the valve to rapidly open and close a fluid connection between the vacuum source or vacuum reservoir and the dross remover. The pressure differential between the atmosphere at the entrance to the dross remover, and the interior of the vacuum source or reservoir causes a rapid flow of gas into the dross remover. In a first preferred embodiment, the dross remover inlet is placed in direct contact with the top of a molten metal pool, and suction force draws material at the top of the molten metal pool into the fluid pathway within the dross remover. In a second preferred embodiment, the dross remover inlet is placed adjacent to the top of a molten metal pool, and the flow of gas may entrain material at the top of the molten metal pool, and pull it into the fluid pathway within the dross remover. If there is dross collected at the top of the molten metal pool, it may also be pulled into the fluid pathway within the dross remover. This has the effect of removing dross from the molten melt pool.

When using the dross remover, it is sometimes preferable to minimize the amount of non-dross material—specifically, clean molten metal—that is captured by the dross remover. This may be accomplished using a variety of techniques. The distance between the dross remover inlet and the pool of molten metal at the time of triggering may be varied to increase or decrease the amount of material pulled into the dross remover. Experimentally, a preferred embodiment is where the dross remover is operated with between 5 mm separation and 1 mm submersion has been identified.

Notably, inlet-melt pool distance provides to some degree a self-regulating mechanism. As the dross remover removes material from the top of the melt pool, the distance between the melt pool and the inlet increases. As this distance increases, less material will be pulled into the dross remover, until eventually no further material is pulled in. This effect can be used to advantage when activating the dross remover in pulses as the effect self-limits how much material will be pulled out. Another embodiment of the dross remover takes advantage of this mechanism to implement an “always-on” dross remover, where the valve is left in the open position during nozzle operation. Only material that enters within some distance of the inlet is pulled into the dross remover, and the amount of material pulled into the dross remover is maintained.

Similarly, the velocity of gas flow through the nozzle may be modulated to limit the material pulled into the dross remover. The pressure of the external atmosphere may be selected to increase or decrease the pressure differential developed when the valve is opened. Likewise, the pressure developed in the vacuum source or vacuum reservoir may be selected to increase or decrease the pressure differential developed when the valve is opened. Experimentally, a preferred embodiment includes a pressure differential between the external atmosphere and the vacuum source of between 90 and 120 millibar.

Similarly, the duration over which the valve is opened may be modulated to limit the material pulled into the dross remover. The duration must be sufficient to develop adequate flow to pull material into the dross remover. However, longer durations may pull more material into the dross remover. Experimentally, in one preferred non-limiting embodiment where the valve open time is between 0.125 and 0.5 seconds has been identified.

As will be clear to one skilled in the art, these quantities may be modulated simultaneously to provide desired dross remover performance. For example, it may be preferable to apply a lower pressure differential for a longer duration, with the inlet closer to the melt pool, to remove dross in certain situations. In other embodiments—such as a dross remover that operates continuously—the valve may be left open for long durations or even constantly, and with inlet-melt pool distance increased.

It may also be preferable to maximize the amount of non-dross material captured by the dross remover. For example, if the user wishes to remove all molten metal from the nozzle for the purposes of nozzle storage or inspection, they may choose to maximize pressure differential; open the valve for a long duration; and move the dross remover inlet so it is substantially submerged in the melt pool.

After dross has been removed from the melt pool and pulled via entrainment into the fluid pathway, the dross is then preferably manipulated so that the fluid pathway is not obstructed, and the dross remover may operate to remove dross repeatedly. An aspect of the present invention is the design of a dross remover which can successfully conduct dross and molten metal through its fluid pathway in this manner.

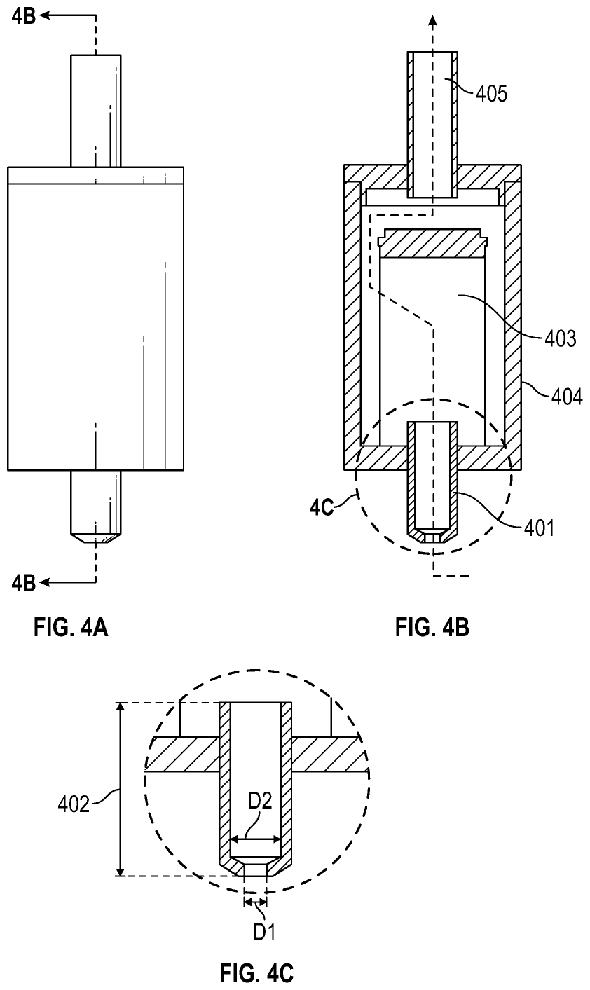

FIGS. 4A-B shows a first preferred embodiment of a dross remover, referred to here as a “vacuum bag dross remover”. FIG. 4B is a cutaway from the vacuum bag dross remover of FIG. 4A and FIG. 4C is a blow up of the inlet region shown in FIG. 4B. In this embodiment, the dross remover inlet is manufactured from a material which may be resistant to high temperatures; and may be resistant to wetting by molten metal. This material may preferably also be able to separate a thin layer of its outer skin under tensile or shear forces. This material may also be further coated with further materials to provide or improve these characteristics. One preferred embodiment of a dross remover uses graphite to manufacture the dross remover inlet. The graphite is resistant to high temperatures, and is strongly non-wetting. Any mechanical bonds formed between the graphite and the dross and molten metal are quite weak, since graphite tends to “exfoliate,” or separate thin layers of its skin under tensile or shear forces. The dross remover inlet may be generally tubular, with its axis aligned with the axis of gas flow. This inlet is referred to here as the dross remover nozzle 401. The design of the dross remover nozzle 401—including elements such as the entry diameter D1, internal contour and length of the dross remover nozzle 401—may be selected to provide specific gas flow characteristics through the nozzle. For example, in areas where the nozzle diameter is smaller, the speed of gas flow through that area will be increased. Conversely, areas with a larger diameter such as D2 may be used to slow the flow of gas, along with any entrained dross and molten metal. In this embodiment, the dross remover nozzle 401 is preferably short in dimension 402 relative to the total length of the fluid pathway, to minimize the amount of time the nozzle is exposed to dross as it flows along it.

Disposed further along the direction of gas flow from this inlet and within the fluid pathway is a gas-porous element, referred to here as the filter 403. Generally gas flows through dross remover body 404 and out through dross remover outlet 405. The filter 403 is manufactured from a material which may be resistant to high temperatures. It may also be resistant to wetting by molten metal. One preferred embodiment of the dross remover uses wire mesh, for example of stainless steel, as a filter material. This filter is preferably replaceable. In the preferred embodiment, when the valve is actuated, gas flow through the dross remover fluid channel will draw dross and molten metal into the dross remover nozzle 401. Because of the dross remover nozzle's non-wetting nature, the dross and any molten metal simultaneously drawn in will not adhere to the dross remover nozzle's interior surfaces. The dross and molten metal will travel through the nozzle into the dross remover fluid channel, where they will encounter the filter 403. The filter 403 may capture the dross and molten metal, preventing them from progressing further through the fluid channel and obstructing the channel. The design of this filter—including elements such as its length, diameter, exterior shape, and pore size—may be selected to provide specific gas flow characteristics through the filter; increase the lifetime of the filter; or filter particles of a specific size, among other metrics.

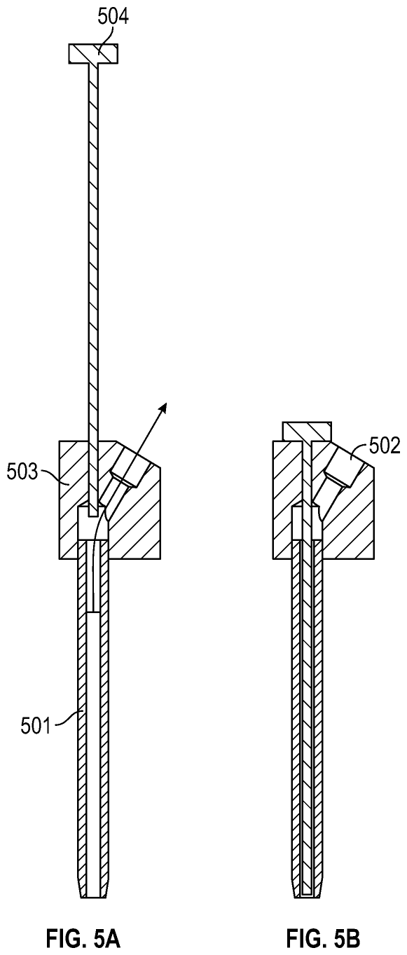

FIG. 5 shows a second preferred embodiment of a dross remover, referred to here as a “nozzle entrapment dross remover”. In this embodiment, the dross remover nozzle 501 is manufactured from a material similar to that described in the first preferred embodiment. This nozzle is preferably long relative to the total length of the fluid pathway, with the intention that the interior of the nozzle is exposed to the dross and molten metal for a longer amount of time as they flow through the nozzle. Distal to the nozzle along the nozzle axis, the fluid flow path may preferably curve away as shown in FIG. 5, and continue to the rest of the dross remover system through outlet 502. The dross remover has a body 503 and retractable ejector pin 504.

The ejector pin 504 is disposed distal to the nozzle along the nozzle axis, as shown in FIG. 5. This ejector pin 504 has a diameter equal to or smaller than the minimum inner diameter of the nozzle. When the valve is actuated, gas flow through the dross remover fluid channel will draw dross and molten metal into the dross remover nozzle. Because of the extended length and internal contours of the dross remover nozzle, the dross and molten metal may accumulate along the inner surface of the nozzle. After the valve has closed, the pin may then be actuated to move through the nozzle against the direction of gas flow, where it may push out the dross and molten metal accumulated inside the nozzle through the nozzle inlet.

A nozzle's geometry may incorporate features such as a chamfer or extended taper at the inner edge of the nozzle inlet, also shown in FIG. 5. This chamfer may make it easier to eject accumulated dross from the interior of the nozzle through the nozzle entry, for instance during operation of the nozzle entrapment dross remover.

During the ejection phase shown in FIG. 5B, the body 503 of the dross remover may be moved relative to the molten metal pool such that any dross ejected to the tip does not fall back into the molten metal pool, and preferably falls into a waste collection receptacle.

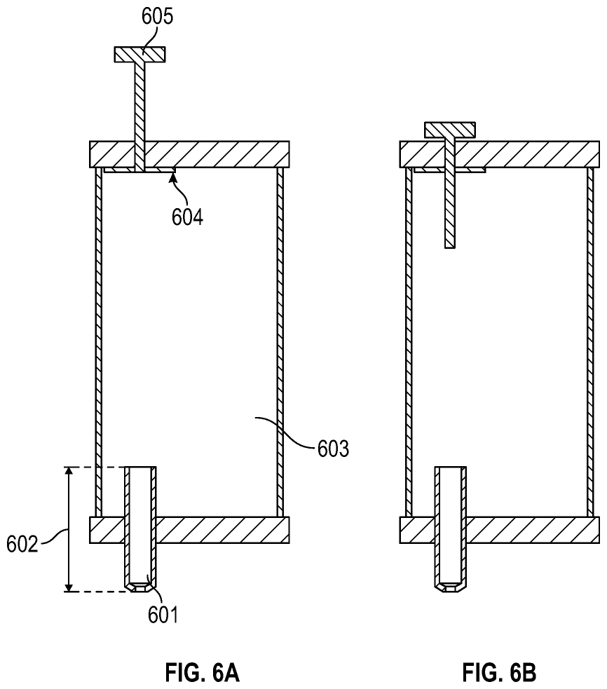

FIG. 6 shows a third preferred embodiment of a dross remover, referred to here as a “splat pad dross remover”. In this embodiment, the dross remover nozzle 601 is similar to the nozzle described in previous embodiments. The nozzle is preferably short in dimension 602 relative to the total length of the fluid pathway. Distal to the nozzle along the nozzle axis is an interior volume of substantially larger cross-sectional area than the nozzle, referred to as the waste bin 603; a flat pad with a hole aligned to the nozzle axis, referred to here as the splat pad 604; and a pin 605. The fluid pathway through the dross remover encompasses the waste bin 603. The fluid path may exit the waste bin 603 at any location, but is preferably located such that it is not aligned with the axis of the nozzle. The nozzle is preferably disposed relative to the waste bin such that there is some distance between the distal end of the nozzle 601 and the end of the waste bin 603 where the splat pad is located. Further, the walls of the waste bin 603 are preferably disposed some distance away from the nozzle axis.

The splat pad 604 may preferably be manufactured from a strongly non-wetting material such as Macor® machineable ceramic (Corning, Inc. of Corning, N.Y.) or boron nitride. It may also preferably be manufactured from a material which can separate a thin layer of its outer skin under tensile or shear forces, such as Grafoil® flexible graphite (Neograf Solutions LLC of New York, N.Y.). It may also preferably be manufactured from a material that is impregnated with a material which impedes wetting, such as an oil-impregnated sintered bronze. It may also be preferably further coated with one or more additional materials to provide or improve these properties. The hole in the center of the splat pad 604 may be closely fit to the outer diameter of the pin 605, so that the pin 605 may be easily actuated to move through the splat pad 604, but gas or material flow in the gap between the pin 605 and splat pad 604 is minimized.

During operation, the pin 605 is positioned so that its end, which may preferably be a flat surface, is coplanar with the face of the splat pad 604 that faces the exit of the nozzle. When the valve is actuated, gas flow through the dross remover fluid channel will draw dross and molten metal into the dross remover nozzle. Dross and molten metal will flow through the nozzle 601 without sticking to it, and into the waste bin 603. Inside the waste bin 603, the dross and molten metal will collide with the splat pad 604, and either a) fall away from the splat pad; or b) adhere weakly to the splat pad. The pin 605 may then be actuated to perform one or more of the following functions: 1) retract from the face of the splat pad, to break any bond between the dross and molten metal and the pin tip; 2) extend through the splat pad, to break the dross and molten metal off of the face of the splat pad 604; or 3) extend further through the nozzle 601, to eject any dross and molten metal remaining in the nozzle 601 out through the nozzle entry. The majority of the dross may collect on the face of the splat pad, and thus will be contained within the waste bin 603.

It is important to ensure that when the dross falls away from the splat pad 604, it does not fall back into the nozzle 601. In the embodiment shown in FIG. 4, the dross remover is angled such that it is aligned relative to gravity as shown. In this manner, when dross falls away from the splat pad, it does not fall back into the nozzle. In other embodiments, different methods may be used to provide the same functionality. For example, a shield may be moved to cover the top of the nozzle before the pin is actuated to break dross free.

During fluid flow through the solder remover, the waste bin 603 must necessarily provide a closed fluid path between the nozzle 601 and the fluid path exit. However, after the fluid flow phase has completed, the waste bin 603 may open to the ambient environment to enable accumulated dross to be removed from the waste bin 603. In one preferred embodiment, the waste bin 603 may be opened by a machine operator intermittently to allow material to be removed. In another preferred embodiment, the waste bin 603 may be opened as part of the solder sucking process to enable material to be carried away by a further mechanism.

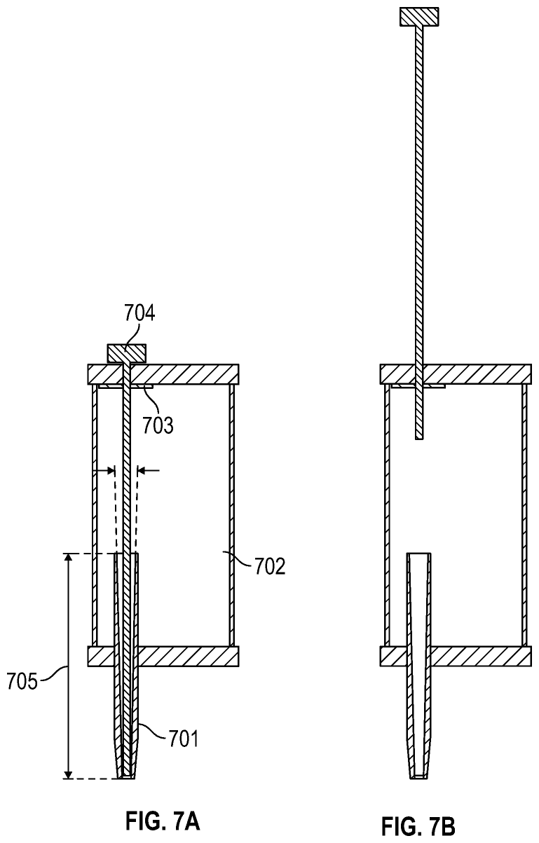

FIG. 7 shows a fourth preferred embodiment of the dross remover, referred to here as a “pin entrapment dross remover”. In this embodiment, the dross remover is designed similarly to the splat pad dross remover, with a nozzle 701, waste bin 702, splat pad 703 and pin 704 disposed along the nozzle axis. In this embodiment, the nozzle 701 may preferably be of a medium length in dimension 705 relative to the total length of the fluid pathway. The nozzle 701 may also have a substantially larger internal diameter relative to the diameter of the pin 704. A 3:1 ratio, by length, between the inner diameter of the nozzle and the outer diameter of the pin 704 has been found to be preferable. The pin 704 may preferably be made from a material which readily forms a weak bond with dross and molten metal, such as highly polished steel. In another preferred embodiment, the pin 704 is made from a material that is non-wetting such as Macor, but which can be mechanically shaped to enable a weak bond with dross and molten metal. For example, grooves along the axis of the pin 704 may be formed into the pin 704. In a third preferred embodiment, one or more additional materials are used to coat the pin 704 and provide the aforementioned weak bond with dross and molten metal.

During operation, the pin 704 is positioned so that its end, which may preferably be a sharp point, is located a short distance away from the nozzle entry within the nozzle 701. This distance is preferably between one and ten nozzle diameters. When the valve is actuated, gas flow through the dross remover fluid channel will draw dross and molten metal into the dross remover nozzle. The flow of the dross and molten metal is impeded partially by the pin 704, and a substantial portion of the dross and molten metal will bond weakly to the length of the pin 704 within the nozzle 701. After the fluid flow phase has completed, the pin 704 may then be retracted through the splat pad 703. The splat pad 703 acts as a die, and shears the accumulated dross and molten metal from the pin, from where it drops down into the waste bin 702.

A nozzle's geometry may incorporate features such as a taper within the nozzle body which extends from a location distal to the nozzle entry and increases in diameter along the nozzle axis, also shown in FIG. 7. This taper may make it easier to pull accumulated dross from the interior of the nozzle through the nozzle and out of the nozzle exit, for instance during operation of the pin entrapment dross remover.

Many elements involved in the construction of a dross remover are preferably resistant to wetting or other mechanical or chemical bonding with molten metals and dross. These elements may be preferably coated with one or more materials, such as boron nitride, to provide this characteristic.

Preferably, the flow of gas may also be used to prevent wetting or other mechanical or chemical bonding with molten metals and dross. As one example, the nozzle may preferably be manufactured from a porous material such as graphite. Gas, such as argon, at an elevated pressure may be provided outside of the nozzle such that it flows through the porosity in the nozzle and exits through the inner surfaces of the nozzle. Similarly, gas at an elevated pressure may also be provided outside of a suitably manufactured splat pad, so that gas exits through the exposed face of the splat pad where dross and molten metal may accumulate.

In other preferred embodiments of a dross remover, two or more of the elements described here may be combined. For instance, the nozzle entrapment dross remover may be combined with a filter element like in a vacuum bag dross remover, with the filter element disposed after the nozzle entrapment system along the gas flow path. In this manner, the nozzle entrapment system may capture larger particles of dross, while the filter element captures smaller particles of dross.

The dross remover may be operated manually. In a preferred embodiment, the dross remover is automated.

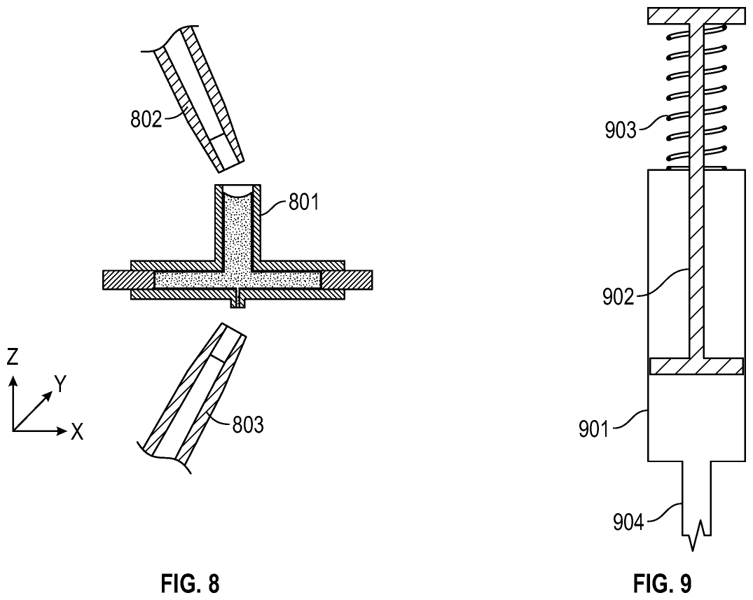

FIG. 8 depicts a jetting nozzle 801 of a print with a melt pool at the top of the nozzle. In addition, a stem is located at the bottom of the nozzle, upon the downward-facing surface of which a smaller melt pool (or meniscus) is naturally formed. The figure further show two possible locations 802 and 803 where a dross remover of the types described herein could be placed to remove dross and other contaminants from either of the melt pools. It will be understood that other nozzles might be designed in such a way that other such pools might be created, and that the remover could be be applied to those as well.

Vacuum suction can be created by the spring-powered motion of a piston in a cylinder, such as that shown in FIG. 9. A cylinder 901 encloses a piston 902 which is driven by a spring 903. Motion of the piston away from nozzle 904 creates an inward suction thereby removing dross.

What is claimed:

1. A dross removal system for additive manufacturing of metal objects using magnetohydrodynamic jetting, comprising:
a vacuum source; and
a dross remover in fluid communication with the vacuum source through a valve, wherein the valve is configured to selectively create a pressure differential at a nozzle sufficient to remove an amount of dross from a molten metal pool.

2. The system of claim 1 further comprising a vacuum reservoir in fluid communication with the vacuum source.

3. The system of claim 1 further comprising a flowmeter configured to measure an amount of flow through a flow pathway between the dross remover and the vacuum source.

4. The system of claim 1, wherein the dross remover includes:
a nozzle and an outlet; and
a body containing a porous filter, wherein a gas flow path interconnects the nozzle to the outlet through the porous filter.

5. The system of claim 4 wherein the nozzle has a length that is short relative to an overall length of the dross remover.

6. The system of claim 4 wherein the nozzle includes an opening having a first diameter that is smaller than a second diameter of an interior throat.

7. The system of claim 1, wherein the dross remover includes:
an elongated nozzle having an internal throat, a nozzle inlet and a nozzle outlet distal to the nozzle inlet; and
an ejector pin sized to occupy the internal throat of the nozzle when in a depressed condition.

8. The system of claim 7 wherein the outlet is disposed at an angle to a flow path of the internal throat.

9. The system of claim 1, wherein the dross remover includes:
a nozzle in fluid communication with a waste bin;
a splat pad; and
an ejector pin configured to be depressed through an opening in the splat pad.

10. The system of claim 9 wherein the nozzle has a tapered interior throat.

11. The system of claim 10 wherein the ejector pin is sized so that a lower surface of the ejector pin traverses the length of the nozzle when in a depressed state.

12. The system of claim 1 wherein the amount of dross removed from the molten metal pool is removed from one of a discharge orifice of a jetting nozzle and a top of the pool of liquid metal in a fluid chamber.

13. A method of dross removal for additive manufacturing of metal objects using magnetohydrodynamic jetting, comprising the steps of:
positioning a dross remover against an amount of dross in a molten metal pool; and
operating a vacuum source in fluid communication with the dross remover through a valve to remove the mount of dross in the molten metal pool.

14. The method of claim 13 wherein the vacuum source is in fluid communication with a vacuum reservoir.

15. The method of claim 13 further comprising the step of measuring via a flowmeter an amount of flow through a flow pathway between the dross remover and the vacuum source.

16. The method of claim 13, wherein the dross remover includes:
a nozzle and an outlet; and
a body containing a porous filter, wherein a gas flow path interconnects the nozzle to the outlet through the porous filter.

17. The method of claim 16 wherein the nozzle has a length that is short relative to an overall length of the dross remover.

18. The method of claim 16 wherein the nozzle includes an opening having a first diameter that is smaller than a second diameter of an interior throat.

19. The method of claim 16, wherein the dross remover includes:
an elongated nozzle having an internal throat, a nozzle inlet and a nozzle outlet distal to the nozzle inlet; and
an ejector pin sized to occupy the internal throat of the nozzle when in a depressed condition.

20. The method of claim 19 wherein the outlet is disposed at an angle to a flow path of the internal throat.

21. The method of claim 13, wherein the dross remover includes:
a nozzle in fluid communication with a waste bin;
a splat pad; and
an ejector pin configured to be depressed through an opening in the splat pad.

22. The method of claim 21 wherein the nozzle has a tapered interior throat.

23. The method of claim 22 wherein the ejector pin is sized so that a lower surface of the ejector pin traverses the length of the nozzle when in a depressed state.

24. The method of claim 13 wherein the amount of dross removed from the molten metal pool is removed from one of a discharge orifice of a jetting nozzle and a top of the pool of liquid metal in a fluid chamber.
